(19) United States
(12) Patent Application Publication
(10) Pub. No.: US 2025/0296525 A1
(43) Pub. Date: Sep. 25, 2025

(54) CURTAIN AIRBAG DEVICE, AIRBAG CASING, AND MOVING OBJECT

(71) Applicant: TOYODA GOSEI CO., LTD., Kiyosu-shi (JP)

(72) Inventors: Ryoichi KATO, Kiyosu-shi (JP); Hiroyuki NAKANISHI, Kiyosu-shi (JP)

(21) Appl. No.: 19/063,445

(22) Filed: Feb. 26, 2025

(30) Foreign Application Priority Data
Mar. 22, 2024 (JP) 2024-045833

(51) Int. Cl. B60R 21/232; B60R 21/213; B60R 21/235; B60R 21/237

(52) U.S. Cl. CPC B60R 21/232; B60R 21/213; B60R 21/235; B60R 21/237; B60R 2021/23538

(57) ABSTRACT

The curtain airbag device for a moving object comprises a bag body configured to inflate and deploy when inflation gas is supplied, and a first engagement portion fixed to the bag body. The first engagement portion is configured to be engageable with a second engagement portion arranged to a holding portion configured to hold the bag body.

### CROSS REFERENCE TO RELATED APPLICATIONS

The present application claims priority based on Japanese Patent Application No. 2024-45833, filed on Mar. 22, 2024, the entire disclosure of which is incorporated herein by reference.

### BACKGROUND

### Field

The present disclosure relates to a curtain airbag device, an airbag casing, and a moving object.

### Related Art

With respect to a curtain airbag device for a moving object, Japanese Patent Laid-Open Publication No. 2006-151176 discloses the technique for attaching and winding a curtain airbag by a tape-shaped member to a bracket attached to a vehicle.

In the document described above, specific consideration has not been given to the proper positioning of the curtain airbag during the attachment of the curtain airbag. For example, it takes time and effort to fix the curtain airbag by a tape-shaped member while holding the curtain airbag so as to prevent positional displacement of the curtain airbag to a subject of the attachment. Moreover, there is a risk of positional displacement of the attachment of the curtain airbag for each person who carries out such work. The positional displacement of the attachment may cause positional and directional displacement of the deployment of the curtain airbag, resulting in an effect on the protective performance of the curtain airbag. Accordingly, the technique is required to reduce positional displacement of the attachment of a curtain airbag while reducing time and effort in the processing of attaching the curtain airbag.

### SUMMARY

The present disclosure may be embodied in the following aspects.
(1) According to a first aspect of the present disclosure, a curtain airbag device for a moving object is provided. The curtain airbag device comprises a bag body configured to inflate and deploy when inflation gas is supplied, and a first engagement portion fixed to the bag body. The first engagement portion is configured to be engageable with a second engagement portion arranged to a holding portion configured to hold the bag body.

### BRIEF DESCRIPTION OF THE DRAWINGS

FIG. 1 is an explanatory diagram of a curtain airbag device;

FIG. 2 is an exploded perspective view illustrating a first engagement portion and a second engagement portion;

FIG. 3 is a diagram for explaining steps of attaching a belt-shaped member to a bag body;

FIG. 4 is a flowchart indicating a method of attaching the bag body to a holding portion;

FIG. 5 is a diagram for explaining a holding portion in a second embodiment.

### DETAILED DESCRIPTION

### A. First Embodiment

### A1. Configuration of Curtain Airbag Device

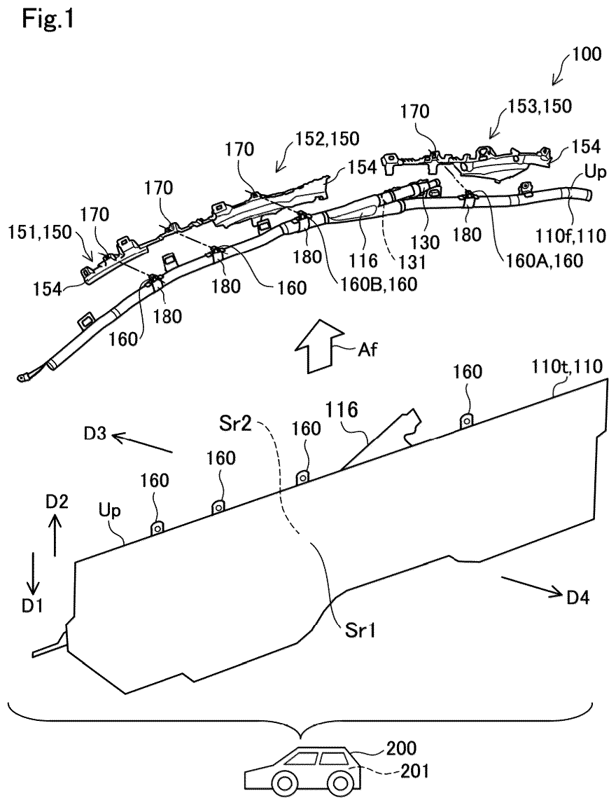

FIG. 1 is an explanatory diagram of a curtain airbag device 100 for a moving object in a first embodiment. FIG. 1 shows the curtain airbag device 100 provided on the right side, of the pair of left and right curtain airbag devices 100 attached to a vehicle 200 as a moving object. The “left and right” in the present disclosure means the left and right of the vehicle 200 when viewed from the rear side to the front side of the vehicle 200. The left and right direction in the present disclosure corresponds to a vehicle width direction.

The curtain airbag device 100 includes a bag body 110, an inflator 130, a casing 150, and a first engagement portion 160. The curtain airbag device 100 in the present embodiment further includes a second engagement portion 170, and a belt-shaped member 180. The casing 150 is also referred to as an airbag casing.

When the curtain airbag device 100 operates, inflation gas is supplied from the inflator 130, and thereby the bag body 110 inflates and deploys. The state in which the bag body 110 is deployed is also referred to as a deployed state. The bag body 110 has a bag-shaped configuration and a substantially rectangular outer shape. In the present embodiment, the bag body 110 is formed using a so-called one-piece-woven (OPW) method, and configured as a single bag-shaped body woven by an automatic loom using. The bag body 110 is made of polyethylene terephthalate, and coated with resin. In another embodiment, the bag body 110 may be formed by a method different from OPW, for example, a method of layering multiple fabrics and stitching them together.

The bag body 110 is in a folded state under normal conditions in which the curtain airbag device 100 is not operating. The folded state means the state in which the bag body 110 is folded, that is, the state in which the bag body 110 is not deployed. FIG. 1 shows a bag body 110f in the folded state, and a bag body 110t in the deployed state. Specifically, as shown an arrow Af in FIG. 1, the bag body 110 transitions from the deployed state to the folded state by rolling up a part including its lower end upward and folding another part including its upper end in a zigzag pattern. The bag body 110f in the folded state has an elongated shape in a direction intersecting with a first direction D1 of the bag body 110f. The first direction D1 represents the direction in which the bag body 110 deploys. In the present embodiment, the first direction D1 is the vertical downward direction. The first direction D1 is also referred to as “a deploying direction of the bag body 110” or “a deploying direction”. The lengthwise direction of the bag body 110f is also referred to simply as “a lengthwise direction”.

The direction opposite to the first direction D1, that is, the direction opposite to the deploying direction, is also referred to as a second direction D2. In the present embodiment, the second direction D2 is the vertical upward direction. The direction from a first surface Sr1 of the deployed bag body 110t to a second surface Sr2 thereof is also referred to as a third direction D3. The first surface Sr1 is the surface of the bag body 110t on the vehicle interior side. The second surface Sr2 is the surface on the side opposite to the first surface Sr1. The direction from the second surface Sr2 of the deployed bag body 110t to the first surface Sr1, that is, the direction opposite to the third direction D3, is also referred to as a fourth direction D4. The third direction D3 and the fourth direction D4 are perpendicular to the first direction D1 and the second direction D2. In the present disclosure, such a perpendicular state includes the range of 90°±10°.

The bag body 110 includes an inlet portion 116. The inlet portion 116 functions as an inlet of inflation gas into the bag body 110, and is configured to receive inflation gas from the inflator 130. The inlet portion 116 is a cylindrical portion. The inlet portion 116 protrudes upward and rearward from the upper portion of the bag body 110t having a substantially rectangular outer shape. The inlet portion 116, which is a part of the bag body 110, is configured by having a part of the fabric of the bag body 110 formed in a cylindrical shape. The inlet portion 116 is subjected to the insertion of a tip 131 of the inflator 130.

The inflator 130 has a function of inflating the bag body 110. The inflator 130 has a substantially columnar shape. The tip 131 of the inflator 130 is inserted in the inlet portion 116 of the bag body 110. The inflator 130 receives a signal from a control unit (not illustrated) of the vehicle 200, and then ejects inflation gas through the tip 131. The inflator 130 may be fixed to a vehicle body 201 of the vehicle 200 via a fixture (not illustrated), for example, a bolt or screw. The vehicle body 201 corresponds to “a main body of a moving object” in the present disclosure.

The casing 150 houses the bag body 110f in the folded state. The casing 150 in the present embodiment includes a first casing 151, a second casing 152, and a third casing 153. The first casing 151, the second casing 152, and the third casing 153 are arranged in this order in the front-rear direction of the vehicle 200. Hereinafter, when the first casing 151, the second casing 152, and the third casing 153 are not distinguished, they may be referred to simply as the casings 150, respectively.

The casing 150 in the present embodiment corresponds to “a holding portion” in the present disclosure. The holding portion is used in order to hold the bag body 110. The bag body 110 is attached to the holding portion, and thereby the holding portion holds the bag body 110. For the sake of ease of technical understanding, FIG. 1 shows a state that the bag body 110f is not held by the casing 150, in other words, the casing 150 and the bag body 110f are separated.

In the present embodiment, the casing 150 has a shaft-like shape along the long bag body 110f, and its cross-sectional shape is substantially semicircular. The casing 150 has a housing portion 154 for housing the bag body 110f in the folded state. In the present embodiment, the recessed portion in the cross-sectional view of the substantially semicircular casing 150 corresponds to the housing portion 154. In other words, the bag body 110 folded into a long shape is housed in the recessed portion corresponding to the housing portion 154.

The bag body 110 and the casing 150 are fixed to the vehicle body 201 of the vehicle 200 so that the bag body 110 deploys in the vehicle interior of the vehicle 200 when the curtain airbag device 100 operates. For example, the bag body 110 may be fixed to the vehicle body 201 via the casing 150. The bag body 110 itself may be fixed to the vehicle body 201 via a fixture. The casing 150 may be fixed to the vehicle body 201 via the bag body 110. The casing 150 itself may be fixed to the vehicle body 201 via a fixture.

The first engagement portion 160 is fixed to the bag body 110. The first engagement portion 160 is configured to be engageable with the second engagement portion 170. In other words, the second engagement portion 170 is configured to be engageable with the first engagement portion 160. In the present disclosure, “engagement” includes “fitting”. The second engagement portion 170 is fixed to the holding portion. In other words, in the present embodiment, the second engagement portion 170 is arranged to the casing 150.

In the present embodiment, the bag body 110 is equipped with the four first engagement portions 160. The casing 150 is equipped with the four second engagement portions 170, corresponding to the four first engagement portions 160. In the case in which the bag body 110 is attached to the casing 150, that is, the case in which the bag body 110 is held by the casing 150, the first engagement portions 160 engage with the corresponding second engagement portions 170, respectively. In FIG. 1, the correspondences between the first engagement portions 160 and the second engagement portions 170 are illustrated by chain double-dashed lines. As shown in FIG. 1, in the present embodiment, a first engagement portion 160A and a first engagement portion 160B are arranged such that the inlet portion 116 is positioned between the first engagement portion 160A and the first engagement portion 160B in the lengthwise direction. Thus, at least a part of the inflator 130 is positioned between the first engagement portion 160A and the first engagement portion 160B in the lengthwise direction. The first engagement portion 160A corresponds to one engagement portion in the plurality of first engagement portions 160. The first engagement portion 160B corresponds to another engagement portion different from the first engagement portion 160A, in the plurality of first engagement portions 160.

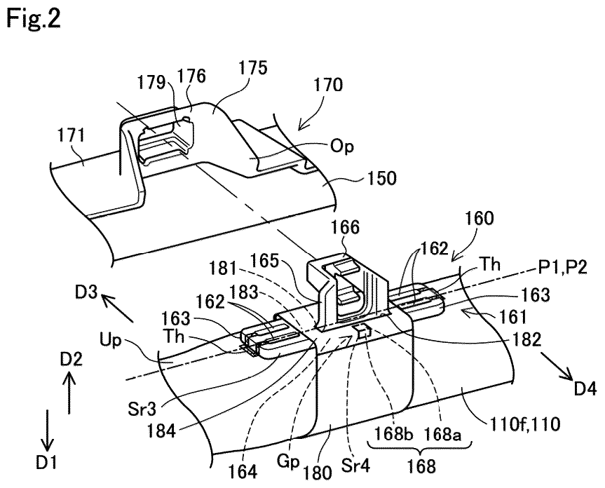

FIG. 2 is an exploded perspective view illustrating the first engagement portion 160 and the second engagement portion 170 in the first embodiment. In the present embodiment, the first engagement portion 160 is configured to be capable of fitting into a fitting hole 179 of the second engagement portion 170. Specifically, the first engagement portion 160 is the resin clip member configured to be capable of fitting into the fitting hole 179 by snap-fit. The first engagement portion 160 has a first base portion 161, a protrusion 165, and a fitting portion 166.

The first base portion 161 has a flat plate shape. The first base portion 161 is arranged on the side of the second direction D2 relative to the bag body 110, that is, arranged on the upper side of the bag body 110. The first base portion 161 is arranged such that the thickness direction of the first base portion 161 aligns with the first direction D1. The first base portion 161, when viewed in the thickness direction of the first base portion 161, has a longitudinal direction and a transverse direction. The first base portion 161 is arranged such that the longitudinal direction of the first base portion 161 aligns with the long bag body 110f.

The first base portion 161 has two ends 163 and a center portion 164. The ends 163 configure the ends in the longitudinal direction of the first base portion 161, in the first base portion 161. The center portion 164 configures the portion positioned between the two ends 163, in the first base portion 161. Each of the ends 163 has a fixing hole 162 that passes through the first base portion 161 in the thickness direction. In the present embodiment, each of the ends 163 has the two fixing holes 162. The first engagement portion 160 is sewn to an upper end surface Up of the bag body 110, via the respective fixing holes 162 of the first base portion 161. In other words, the first engagement portion 160 is fixed to the bag body 110 via the fixing holes 162 by use of a thread Th. Specifically, each of the ends 163 is sewn respectively to the upper end surface Up, via the pair of fixing holes 162 arranged in each of the ends 163. FIG. 2 shows the thread Th schematically illustrated by hatching.

The first base portion 161 in the present embodiment is equipped with a pressing portion 168. In FIG. 2, the pressing portion 168 is schematically illustrated by broken lines. The pressing portion 168 has a first portion 168a and a second portion 168b. The first portion 168a extends in the fourth direction D4 from the upper end of a surface Sr3 of the first base portion 161 in the fourth direction D4. The first portion 168a has a flat plate shape, and is arranged such that the plate face of the first portion 168a is positioned perpendicular to the first direction D1 and the second direction D2. The second portion 168b extends in the first direction D1 from the end of the first portion 168a in the fourth direction D4. The second portion 168b has a flat plate shape, and is arranged such that the plate face of the second portion 168b is positioned perpendicular to the third direction D3 and the fourth direction D4. There is a gap Gp between the first base portion 161 and the second portion 168b. The gap Gp is positioned between the surface Sr3 and a surface Sr4. The surface Sr4 is the surface of the second portion 168b in the third direction D3.

The protrusion 165 protrudes in the second direction D2 from the bag body 110, that is, upward. In the present embodiment, the protrusion 165 is configured as the portion standing in the second direction D2 from the center portion 164 of the first base portion 161. The protrusion 165 is thus positioned between the two ends 163, in the longitudinal direction of the first base portion 161. The protrusion 165 has a flat plate shape. The protrusion 165 is arranged such that the plate face of the protrusion 165 is positioned perpendicular to the third direction D3 and the fourth direction D4.

The fitting portion 166 is the portion configured to be capable of fitting into the fitting hole 179. In the present embodiment, the fitting portion 166 is configured as the portion protruding in the third direction D3 from the upper end of the protrusion 165. The fitting portion 166 fits into the fitting hole 179 by snap-fit.

The second engagement portion 170 is configured as a resin holder. The second engagement portion 170 is fixed on the side of the second direction D2 to the housing portion 154, that is, on the upper side of the housing portion 154. The second engagement portion 170 has a second base portion 171 and a reception portion 175. The second base portion 171 has a flat plate shape, and is arranged such that the thickness direction of the second base portion 171 aligns with the first direction D1. The reception portion 175 receives the fitting portion 166. The reception portion 175 is configured as the recessed portion that is recessed in the third direction D3, and has an opening Op which opens toward the fourth direction D4. The reception portion 175 has a bottom portion 176 of the opening Op, and the fitting hole 179 is arranged in the bottom portion 176. The configuration described above allows the reception portion 175 to receive the fitting portion 166 in the opening Op, and further allows the fitting portion 166 to fit into the fitting hole 179.

The belt-shaped member 180 has a long belt-like shape. The belt-shaped member 180 is configured to keep the folded state under normal conditions. The belt-shaped member 180 is configured to break when the bag body 110 inflates and deploys. The belt-shaped member 180 is wound around the folded bag body 110f, and thereby keeps the folded state. In the present embodiment, the belt-shaped member 180 is made of non-woven fabric.

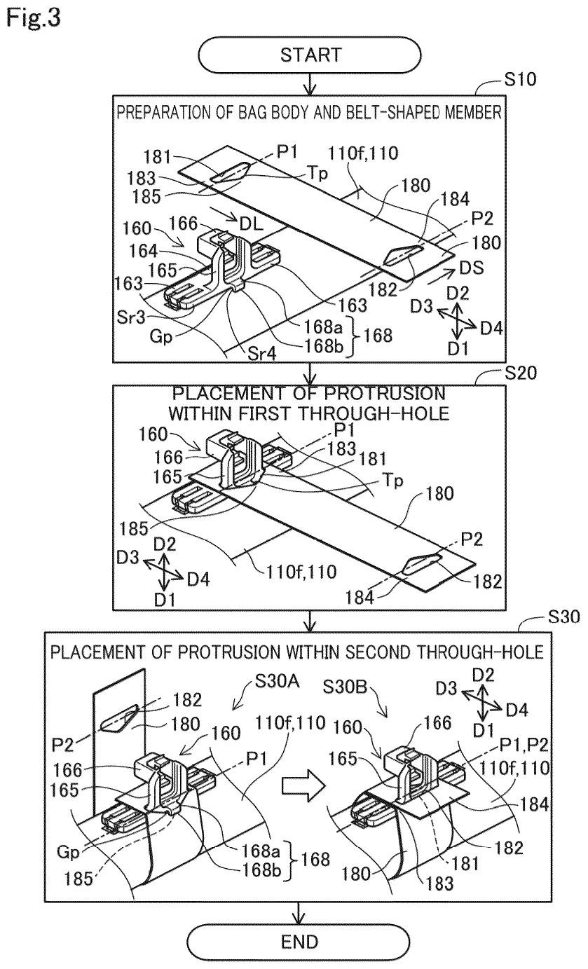

FIG. 3 is a diagram for explaining steps of attaching the belt-shaped member 180 to the bag body 110f. The respective steps shown in FIG. 3 correspond to at least a part of the method of producing the curtain airbag device 100 in the present embodiment.

In step S10, the bag body 110 having the first engagement portion 160 fixed thereto, and the belt-shaped member 180 are prepared.

In FIG. 2 as described above, the belt-shaped member 180 attached to the bag body 110f is illustrated, while in step S10 in FIG. 3, the belt-shaped member 180 before being attached to the bag body 110 is illustrated. As shown in FIG. 2 and FIG. 3, the belt-shaped member 180 has a first through-hole 181 and a second through-hole 182. The first through-hole 181 is arranged at a first position P1 of the belt-shaped member 180. The second through-hole 182 is arranged at a second position P2 of the belt-shaped member 180. The first position P1 and the second position P2 represent positions in a longitudinal direction DL of the belt-shaped member 180. In the present embodiment, the first position P1 is positioned in a first end 183 in the longitudinal direction DL of the belt-shaped member 180. The second position P2 is positioned in a second end 184 in the longitudinal direction DL of the belt-shaped member 180. Each of the first through-hole 181 and the second through-hole 182 passes through the belt-shaped member 180 in the thickness direction of the belt-shaped member 180.

As shown in FIG. 3, in the present embodiment, each of the first through-hole 181 and the second through-hole 182 has a substantially triangular opening shape. Specifically, each of the openings of the through-holes has a substantially triangular shape in which the opening width at the center portion in the longitudinal direction DL of the through-hole is wider than the opening width at the both ends in the longitudinal direction DL of the through-hole. The opening width described above means the opening diameter in a transverse direction DS of the belt-shaped member 180. More specifically, the first through-hole 181 has the triangular opening shape in which the center portion in the longitudinal direction DL of the first through-hole 181 protrudes toward the second through-hole 182. The second through-hole 182 has the triangular opening shape protruding in the direction opposite to the protruding direction of the first through-hole 181, in the longitudinal direction DL. Hereinafter, the top that protrudes toward the second through-hole 182, of the opening shape of the first through-hole 181 is also referred to as a top portion Tp. The top portion Tp is sectioned by a top edge 185 of the belt-shaped member 180.

In step S20, the protrusion 165 of the first engagement portion 160 is placed into the first through-hole 181 of the belt-shaped member 180. Specifically, the fitting portion 166 and the protrusion 165 are inserted into the first through-hole 181, thereby placing the lower end of the protrusion 165 within the first through-hole 181.

In step S30, the belt-shaped member 180 is wound around the bag body 110f, and the protrusion 165 is placed into the second through-hole 182 of the belt-shaped member 180. Specifically, while keeping the state in which the protrusion 165 is placed within the first through-hole 181 and the state in which the bag body 110f is folded, the belt-shaped member 180 is wound around the bag body 110f and the fitting portion 166 and the protrusion 165 are inserted into the second through-hole 182. FIG. 3 shows a state S30A in which the belt-shaped member 180 is in the middle of being wound, and a state S30B in which the belt-shaped member 180 has been wound.

In the present embodiment, in either step S20 or step S30, the top edge 185 of the belt-shaped member 180 is placed into the gap Gp positioned between the surface Sr3 of the center portion 164 and the surface Sr4 of the pressing portion 168. FIG. 3 shows an example in which the top edge 185 is placed into the gap Gp in step S30.

As the processing from step S10 to step S30 is executed, the belt-shaped member 180, in the range from the first position P1 to the second position P2 of the belt-shaped member 180, is wound around the bag body 110f such that the protrusion 165 is placed within the first through-hole 181 and the second through-hole 182. Specifically, the belt-shaped member 180 from the first end 183 to the second end 184 is wound around the bag body 110f. As a result, as shown in FIG. 2, the belt-shaped member 180 is attached to the bag body 110f. In the state in which the belt-shaped member 180 is attached to the bag body 110f as shown in FIG. 2, the second end 184 and the first end 183 overlap each other vertically, and the second through-hole 182 and the first through-hole 181 are connected each other vertically. Specifically, in FIG. 2, the first end 183 and the first through-hole 181 are positioned below the second end 184 and the second through-hole 182, respectively.

As described above, the belt-shaped member 180 is configured to break at the time of operation. Specifically, inflation gas is supplied from the inflator 130 to the bag body 110f at the time of operation, and thereby the bag body 110f starts to inflate and deploy. As a result, the application of an external force to the belt-shaped member 180 from the inner side of the wound belt-shaped member 180, that is, from the bag body 110, breaks the belt-shaped member 180. In this case, for example, a portion in the vicinity of the first through-hole 181 or the second through-hole 182 breaks primarily because it is relatively weak in strength compared to other portions in the belt-shaped member 180. It is preferable that, for example, the dimension, thickness, material, and fiber density of the belt-shaped member 180, and the opening diameters, opening areas, opening shapes and the like of the first through-hole 181 and the second through hole 182 are selected, in order that the belt-shaped member 180 appropriately breaks at the time of operation, and further that the belt-shaped member 180 appropriately keeps the folded state of the bag body 110f under normal conditions.

### A2. Attachment of Bag Body to Holding Portion

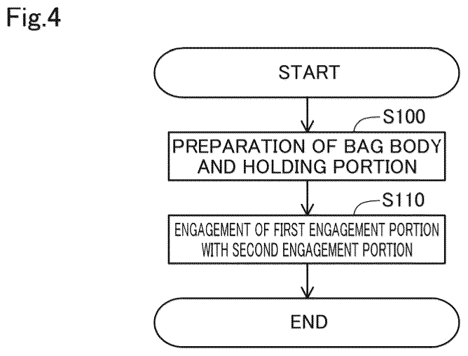

FIG. 4 is a flowchart indicating a method of attaching the bag body 110 to the holding portion. The respective steps shown in FIG. 4 correspond to at least a part of the method of producing the curtain airbag device 100 in the present embodiment.

In step S100, the bag body 110f and the holding portion are prepared. In step S100 in the present embodiment, the bag body 110f after the execution of step S30 shown in FIG. 3 is prepared as the bag body 110f. The casings 150 are prepared as the holding portion.

In step S110, the bag body 110f is inserted into the housing portions 154 of the casings 150, and the first engagement portions 160 are engaged with the second engagement portions 170. In other words, in step S110, the bag body 110f is inserted into the housing portions 154, and the fitting portions 166 of the first engagement portions 160 are fitted into the fitting holes 179 of the second engagement portions 170. As a result, the bag body 110 is attached to the casing 150. The processing of attaching the bag body 110 to the holding portion as in step S110 is also referred to as attaching processing. After the execution of step S110, for example, at least one of the bag body 110 or the casings 150 housing the bag body 110 is fixed to the vehicle body 201 via various fixtures.

In the first embodiment described above, the curtain airbag device 100 includes the first engagement portion 160 fixed to the bag body 110. The first engagement portion 160 is configured to be engageable with the second engagement portion 170 of the casing 150 serving as the holding portion. With the configuration above, the engagement between the first engagement portion 160 and the second engagement portion 170 allows the bag body 110f to be attached to the casing 150. Accordingly, the configuration described above reduces positional displacement of the attachment of the bag body 110 to the casing 150, while reducing time and effort in the attaching processing, compared to, for example, the case in which the bag body 110f is fixed to the casing 150 by tape, while the relative position of the bag body 110f to the casing 150 is being adjusted. Moreover, the configuration described above reduces time and effort in the attaching processing, compared to the case in which the bag body 110f is attached to the casing 150 via a fixture such as a bolt or screw. As described above, the configuration reduces positional displacement of the attachment of the bag body 110 to the casing 150, while reducing time and effort in the attaching processing.

In the present embodiment, the first engagement portion 160 is sewn to the bag body 110. This allows for strong and space-saving fixing of the first engagement portion 160 to the bag body 110. Specifically, compared to, for example, the case in which the first engagement portion 160 is fixed to the bag body 110 via a fixture such as a bolt or screw, this allows for space-saving fixing of the first engagement portion 160 to the bag body 110. This also allows for fixing of the first engagement portion 160 to the bag body 110 without the use of adhesive agent.

In the present embodiment, the belt-shaped member 180 is arranged. The belt-shaped member 180, in the range from the first position P1 to the second position P2, is wound around the folded bag body 110f such that the protrusion 165 is placed within the first through-hole 181 and the second through-hole 182. Accordingly, the use of the protrusion 165 of the first engagement portion 160 allows the belt-shaped member 180 to keep the folded state.

In the present embodiment, the first engagement portion 160 has the pressing portion 168. A part of the belt-shaped member 180 is placed into the gap Gp positioned between the pressing portion 168 and the first base portion 161. This reduces the likelihood of unintentional unraveling of the wound belt-shaped member 180, for example, under normal conditions or in the middle of attachment of the belt-shaped member 180. In the present embodiment, the first through-hole 181 has the top portion Tp, and this allows a part of the belt-shaped member 180 to be smoothly placed into the gap Gp, compared to the configuration without the top portion Tp in the first through-hole 181. Specifically, the top edge 185 can be smoothly placed into the gap Gp. The belt-shaped member 180 allows a tear to form starting from the top portion Tp in the case where an external force is applied to the belt-shaped member 180 from the bag body 110 when the bag body 110 deploys. Accordingly, the belt-shaped member 180 easily and appropriately breaks when the curtain airbag device 100 operates.

In the present embodiment, the belt-shaped member 180 is made of non-woven fabric. Thus, the belt-shaped member 180 is configured easily. Specifically, the belt-shaped member 180, which keeps the folded state under normal conditions and breaks at the time of operation, is configured easily.

In the present embodiment, the inlet portion 116 is positioned between the first engagement portion 160A which is one engagement portion, and the first engagement portion 160B which is another engagement portion different from the first engagement portion 160A, in the lengthwise direction. As a result, at least a part of the inflator 130, which is a member having a relatively large mass, is positioned between the first engagement portion 160A and the first engagement portion 160B, in the lengthwise direction. This reduces time and effort relative to the mass of the inflator 130 in the attaching processing, compared to the configuration in which the inlet portion 116 is not arranged between the first engagement portions 160.

In the present embodiment, the first engagement portion 160 has the fitting portion 166 configured to be capable of fitting into the fitting hole 179 arranged in the second engagement portion 170. Thus, the fitting portion 166 fits into the fitting hole 179, thereby attaching the bag body 110f to the casing 150. This further reduces time and effort in the attaching processing.

In the casing 150 in the present embodiment, the second engagement portion 170 is fixed to the housing portion 154. This allows for the provision of the casing 150 which reduces positional displacement of the attachment, while reducing time and effort in the attaching processing.

### B. Second Embodiment

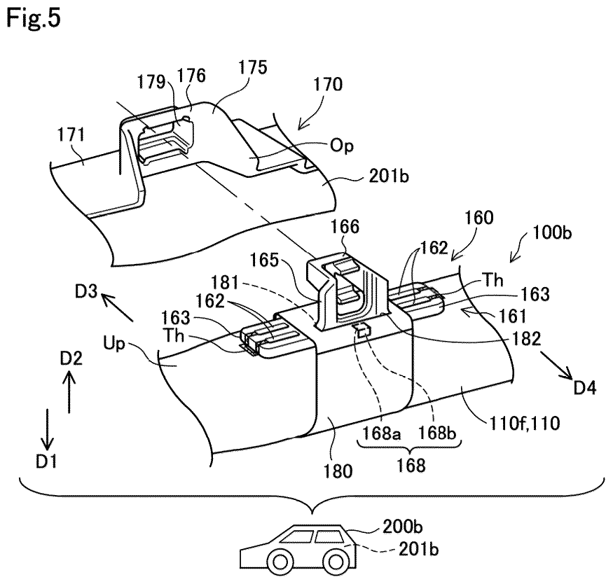

FIG. 5 is a diagram for explaining a curtain airbag device 100b and a holding portion in the second embodiment. In the present embodiment, the curtain airbag device 100b has no casing 150, unlike the first embodiment. In the present embodiment, a vehicle 200b functions as the holding portion in the present disclosure. The curtain airbag device 100b and the vehicle 200b in the second embodiment have the same configurations as those in the first embodiment, respectively, unless otherwise specified.

In the present embodiment, the respective second engagement portions 170 are fixed to a vehicle body 201b of the vehicle 200b. In the present embodiment, the respective first engagement portions 160 of the curtain airbag device 100b are engaged with the respective second engagement portions 170 of the vehicle 200b, thereby attaching the curtain airbag device 100b to the vehicle 200b serving as the holding portion.

The curtain airbag device 100b in the second embodiment described above also reduces positional displacement of the attachment of the bag body 110, while reducing time and effort in the attaching processing. In the vehicle 200b in the present embodiment, the second engagement portion 170 is fixed to the vehicle body 201b. This allows for the provision of the vehicle 200b which reduces positional displacement of the attachment, while reducing time and effort in the attaching processing.

In the present embodiment, the engagement between the first engagement portion 160 and the second engagement portion 170 is released when desired, thereby easily detaching the curtain airbag device 100b from the vehicle body 201b. This facilitates replacement, inspection, and repair of the curtain airbag device 100b, thus enhancing maintenance performance of the curtain airbag device 100b.

### C. Other Embodiments

(C1) In the respective embodiments described above, the first engagement portion 160 is sewn to the bag body 110. Alternatively, the first engagement portion 160 may be fixed to the bag body 110 by various methods other than the sewing. For example, the first engagement portion 160 may be fixed to the bag body 110 by various fixtures, or by using adhesive agent.
(C2) In the respective embodiments described above, the curtain airbag device 100 may not include the belt-shaped member 180. For example, the curtain airbag device 100 may be kept in the folded state, by a member different from the belt-shaped member 180, such as a member that has a belt-like shape, a string-like member, or a fastener, in addition to, or instead of the belt-shaped member 180.
(C3) In the respective embodiments described above, the belt-shaped member 180 is made of non-woven fabric. Alternatively, the belt-shaped member 180 may not be made of non-woven fabric. For example, the belt-shaped member 180 may be made of various types of material, such as paper, metal, resin, or woven fabric.
(C4) In the respective embodiments described above, the first engagement portion 160 has the fitting portion 166. Alternatively, the first engagement portion 160 may not have the fitting portion 166. For example, the second engagement portion 170 may have a fitting portion, while the first engagement portion 160 may have a fitting hole capable of fitting into the fitting portion arranged to the second engagement portion 170. The first engagement portion 160 may be configured to be engageable with the second engagement portion 170 in a manner different from fitting. For example, the first engagement portion 160 may be configured to be engageable with the second engagement portion 170 by sliding.
(C5) In the respective embodiments described above, the respective numbers of the first engagement portions 160 and the second engagement portions 170 are four. Alternatively, the respective numbers of the first engagement portions 160 and the second engagement portions 170 may be three or less, or may be five or more. The first engagement portions 160 and the second engagement portions 170 may be arranged arbitrarily as long as a holding portion can hold the bag body 110.
(C6) In the respective embodiments described above, the second engagement portion 170 may be formed integrally with the holding portion, thereby being fixed to the holding portion. For example, in the first embodiment, the second engagement portion 170 may be configured integrally with the housing portion 154, thereby being fixed to the housing portion 154. In the second embodiment, the second engagement portion 170 may be configured integrally with the vehicle body 201b, thereby being fixed to the vehicle body 201b.
(C7) In the respective embodiments described above, the vehicle 200 is provided as a moving object. Alternatively, various types of moving object different from the vehicle 200 may be provided. The moving object may be various types of moving object capable of accommodating passengers for example, like vessel, airplane, spacecraft, or so-called flying car.
(C8) In the respective embodiments described above, the airbag casing and the moving object are provided as the holding portion. Alternatively, various types of holding portion that holds the bag body 110 may be provided, other than the airbag casing or the moving object.

The present disclosure may be embodied in various aspects without departing from the spirit of the present disclosure, not limited to the above-described embodiments. For example, the technical features in the embodiments described above may be appropriately replaced or combined in order to solve some or all of the above-described problems, or in order to achieve some or all of the above-described effects. Any of the technical features not described as essential in the present specification may be omitted appropriately. For example, the present disclosure may be embodied in the following aspects.
(1) According to a first aspect of the present disclosure, a curtain airbag device for a moving object is provided. The curtain airbag device comprises a bag body configured to inflate and deploy when inflation gas is supplied, and a first engagement portion fixed to the bag body. The first engagement portion is configured to be engageable with a second engagement portion arranged to a holding portion configured to hold the bag body.

According to this aspect, the engagement between the first engagement portion and the second engagement portion allows the bag body to be attached to the holding portion. Accordingly, the above aspect may reduce positional displacement of the attachment of the bag body to the holding portion, while reducing time and effort in the processing of attaching the bag body to the holding portion.
(2) In the aspect described above, the first engagement portion may be sewn to the bag body. This aspect allows for strong and space-saving fixing of the first engagement portion to the bag body.
(3) In the aspect described above, the curtain airbag device may further comprise a belt-shaped member configured to keep the folded bag body in a folded state and to break when the bag body inflates and deploys. The first engagement portion may have a protrusion protruding in a direction opposite to a deploying direction of the bag body. The belt-shaped member may have a first through-hole arranged at a first position of the belt-shaped member, and a second through-hole arranged at a second position of the belt-shaped member. The first position and the second position may represent positions in a longitudinal direction of the belt-shaped member, respectively. The belt-shaped member, in a range from the first position to the second position, may be wound around the folded bag body such that the protrusion is placed within the first through-hole and the second through-hole. According to this aspect, the use of the protrusion of the first engagement portion allows the belt-shaped member to keep the folded state.
(4) In the aspect described above, the belt-shaped member may be made of non-woven fabric. According to this aspect, the belt-shaped member is configured easily.
(5) In the aspect described above, the bag body may have an inlet portion configured to receive the inflation gas supplied from an inflator. The first engagement portion may include one engagement portion and another engagement portion, and the one engagement portion and the another engagement portion may be arranged such that the inlet portion is positioned between the one engagement portion and the another engagement portion in a lengthwise direction of the bag body folded into a long shape. This aspect may reduce time and effort relative to the mass of the inflator having a relatively large mass, in attaching processing.
(6) In the aspect described above, the first engagement portion may have a fitting portion configured to be capable of fitting into a fitting hole arranged in the second engagement portion. This aspect may reduce time and effort in the processing of attaching the bag body to the holding portion.
(7) According to a second aspect of the present disclosure, an airbag casing is provided. The airbag casing comprises a housing portion configured to house a bag body which is in a folded state, included in a curtain airbag device for a moving object, the bag body being configured to inflate and deploy when inflation gas is supplied, and a second engagement portion being configured to be engageable with a first engagement portion fixed to the bag body, the second engagement portion being fixed to the housing portion.
(8) According to a third aspect of the present disclosure, a moving object subjected to attachment of a curtain airbag device is provided. The moving object comprises a main body of the moving object, and a second engagement portion configured to be engageable with a first engagement portion fixed to a bag body of the curtain airbag device, the second engagement portion being fixed to the main body of the moving object.

The present disclosure may also be embodied in various aspects other than the aspects of the curtain airbag device, the airbag casing, and the moving object described above, for example, a method of producing a curtain airbag device, and a method of producing a moving object.

What is claimed is:

1. A curtain airbag device for a moving object, the curtain airbag device comprising:
a bag body configured to inflate and deploy when inflation gas is supplied; and
a first engagement portion fixed to the bag body, wherein
the first engagement portion is configured to be engageable with a second engagement portion arranged to a holding portion configured to hold the bag body.

2. The curtain airbag device according to claim 1, wherein
the first engagement portion is sewn to the bag body.

3. The curtain airbag device according to claim 1, the curtain airbag device further comprising
a belt-shaped member configured to keep the folded bag body in a folded state and to break when the bag body inflates and deploys, wherein
the first engagement portion has a protrusion protruding in a direction opposite to a deploying direction of the bag body,
the belt-shaped member has a first through-hole arranged at a first position of the belt-shaped member, and a second through-hole arranged at a second position of the belt-shaped member, the first position and the second position representing positions in a longitudinal direction of the belt-shaped member, respectively, and
the belt-shaped member, in a range from the first position to the second position, is wound around the folded bag body, such that the protrusion is placed within the first through-hole and the second through-hole.

4. The curtain airbag device according to claim 3, wherein
the belt-shaped member is made of non-woven fabric.

5. The curtain airbag device according to claim 1, wherein
the bag body has an inlet portion configured to receive the inflation gas supplied from an inflator,
the first engagement portion includes one engagement portion and another engagement portion, and
the one engagement portion and the another engagement portion are arranged such that the inlet portion is positioned between the one engagement portion and the another engagement portion in a lengthwise direction of the bag body folded into a long shape.

6. The curtain airbag device according to claim 1, wherein
the first engagement portion has a fitting portion configured to be capable of fitting into a fitting hole arranged in the second engagement portion.

7. An airbag casing comprising:
a housing portion configured to house a bag body in a folded state, the bag body included in a curtain airbag device for a moving object, the bag body being configured to inflate and deploy when inflation gas is supplied; and
a second engagement portion configured to be engageable with a first engagement portion fixed to the bag body, the second engagement portion being fixed to the housing portion.

8. A moving object subjected to attachment of a curtain airbag device, the moving object comprising:
a main body of the moving object; and
a second engagement portion configured to be engageable with a first engagement portion fixed to a bag body of the curtain airbag device, the second engagement portion being fixed to the main body of the moving object.
